(19) United States
(12) Patent Application Publication
(10) Pub. No.: US 2013/0213167 A1
(43) Pub. Date: Aug. 22, 2013

(54) HOLLOW GEAR RING AND METHOD FOR ITS MANUFACTURING

(71) Applicants: Patrik Dahlman, Shanghai (CN); Baozhu Liang, Dittelbrunn-Hambach (DE)

(72) Inventors: Patrik Dahlman, Shanghai (CN); Baozhu Liang, Dittelbrunn-Hambach (DE)

(21) Appl. No.: 13/807,952

(22) PCT Filed: May 27, 2011
(86) PCT No.: PCT/SE2011/000097

§ 371 Date: Mar. 15, 2013

(30) Foreign Application Priority Data
Jul. 2, 2010 (SE) 1000724-3

(51) Int. Cl. B23F 21/00; F16H 55/02

(52) U.S. Cl. CPC B23F 21/00; F16H 55/02
USPC 74/434; 29/893

(57) ABSTRACT

A welded hollow gear ring (160, 260, 360, 460, 560) with an outer (140, 240, 340) and an inner (155, 255, 355) periphery, which exhibits a gear structure (131-138, 231-238, 331-338, 331′-338′) on at least one periphery, as well as exhibiting at least one welding joint (151, 251, 351, 451, 551) which has been formed by flash butt welding. The gear structure is formed by rolling, machining, or by a combination of machining and rolling. The gear structure can comprise cogs or helical gears.

### CROSS-REFERENCE TO RELATED APPLICATION

This application is a National Stage application claiming the benefit of International Application Number PCT/SE2011/000097 filed on 27 May 2011, which claims the benefit of SE Application 1000724-3 Filed on 2 Jul. 2010.

### TECHNICAL FIELD

The present invention discloses an improved hollow gear ring and a method for manufacturing such an improved hollow gear ring.

### BACKGROUND

Hollow gear rings are a common component in many areas of mechanical technology. A hollow gear ring will, as the name implies, comprise a ring shaped body with an inner and an outer periphery, with a gear structure on one or both of the peripheries. The gear structure can comprise protrusions, such as, for example, cogs in the form of “teeth”, or other structures such as, for example, helical gears.

Examples of traditional ways of forming hollow gear rings include attaching a gear structure to the outer or inner periphery of a smooth hollow ring, or forming a gear structure on the periphery, outer or inner, of the hollow ring, by means of machining.

A drawback of the first method i.e. attaching a gear structure to a hollow ring is that the joint between the gear structure and the hollow ring to which it is attached will be weakened over time by such factors as stress, wear, creeping and fretting corrosion, which may eventually cause the joint to come apart.

A drawback of the second method, i.e. machining a gear structure in the periphery, inner or outer, of a hollow ring, is that machining a gear structure inherently causes weaknesses in the structure.

A drawback in general of traditional methods of manufacturing hollow gear rings include difficulties in manufacturing the hollow gear rings with a sufficient degree of preciseness and quality, both in the gears as such, as well as in the entire structure as compared to, for example, such gear designs as sun gears and planetary gears.

### SUMMARY

A purpose of the present invention is to provide a hollow gear ring which does not exhibit the above mentioned drawbacks of known gear rings, and to also provide at least one method for manufacturing such a hollow gear ring.

This purpose is met by the present invention in that it discloses a welded hollow gear ring with an outer and an inner periphery. The welded hollow gear ring exhibits a gear structure on at least one of its peripheries, and also exhibits at least one welding joint. According to the invention, the welding joint has been formed by flash butt welding.

This is advantageous due to the fact that flash butt welding provides an exceptionally strong welding joint. In addition, due to the fact that the hollow gear ring of the invention exhibits at least one welding joint formed by flash butt welding, the gear structure can be formed on a straight steel bar, which is then bent to a ring shape and flash butt welded together. This means that the gear structure can be formed on or in the steel bar, so that standard gear manufacturing technology can be used, such as, for example, technologies used in the manufacturing of linear transmissions, which will result in lower costs and higher quality as compared to traditional methods of manufacturing hollow gear rings.

In addition, the use of flash butt welding enables the use of steel with a higher carbon content than the steel used in traditional methods of manufacturing a gear ring with a gear structure. Due to the fact that flash- butt welding is used, steel with a high carbon content, e.g. in excess of 0.67% can be used to manufacture the gear ring of the invention, which means that the gear ring of the invention may be stronger than traditional such gear rings, or it may be comparable in quality and performance but to a lower cost.

In one embodiment, the gear structure has been formed by rolling, whilst it, in another embodiment has been formed by machining. In a further embodiment, the gear structure has been formed by a combination of machining and rolling.

In one embodiment of the invention, the welded hollow gear ring exhibits a gear structure on both peripheries, i.e. there is one gear structure facing outwards from the outer periphery and one gear structure facing inwards from the inner periphery of the ring.

In one embodiment of the invention, the gear structure of the welded hollow gear ring comprises cogs, and in another embodiment, it comprises helical gears. In one such embodiment of the welded hollow gear ring, at least one welding joint is located between two cogs or between two helical gears.

The invention also discloses a method for manufacturing a welded hollow gear ring, comprising the following:

Forming a first gear structure on a first main surface of an elongated steel bar,

Bending the steel bar to form a ring, so that two opposing distal ends of the steel bar meet,

Joining the two meeting ends of the steel bar to each other by means of flash butt welding.

The invention also discloses a method for manufacturing a welded hollow gear ring which comprises the following:

Forming a first gear structure on a first main surface of each of two or more elongated steel bars,

Bending the two or more steel bars so that they each form ring segments of a ring with a first radius,

Joining ends of said two or more steel bars two to each other by means of flash butt welding, in order to form a welded hollow gear ring with said first radius.

In one embodiment of the method, the steel bar is bent to form a ring in such a manner that the gear structure faces inwards from an inner periphery of the ring or ring segments.

In one embodiment of the method, the steel bar is bent to form a ring in such a manner that the gear structure faces outwards from an outer periphery of the ring or ring segments.

In one embodiment, the method additionally comprises forming a second gear structure on a second main surface of the steel bar or bars, with the second main surface being opposite to the first main surface of the steel bar or bars.

In one embodiment, the gear structure or structures is/are formed by rolling.

In one embodiment, the gear structure or structures is/are formed by machining.

In one embodiment, the gear structure or structures is/are formed by a combination of machining and rolling.

In one embodiment, the gear structure is formed to comprise cogs, whilst, in one embodiment, the gear structure is formed to comprise helical gears. In one such embodiment of the method, the gear structure is formed to comprise an entire cog or helical gear adjacent to each end of the steel bar or bars, thus enabling the welding to be performed between two cogs or helical gears.

These and other embodiments of the invention, as well as advantages obtained by means of the invention will be described in the following text.

### BRIEF DESCRIPTION OF THE DRAWINGS

The invention will be described in more detail in the following, with reference to the appended drawings, in which

FIGS. 1a-1d show a first embodiment of the invention, and

FIGS. 2a-2d shows a second embodiment of the invention, and

FIGS. 3a-3d shows a third embodiment of the invention, and

FIG. 4 shows a fourth embodiment of the invention, and

FIG. 5 shows a fifth embodiment of the invention, and

FIGS. 6 and 7 show further embodiments of the invention.

### DETAILED DESCRIPTION

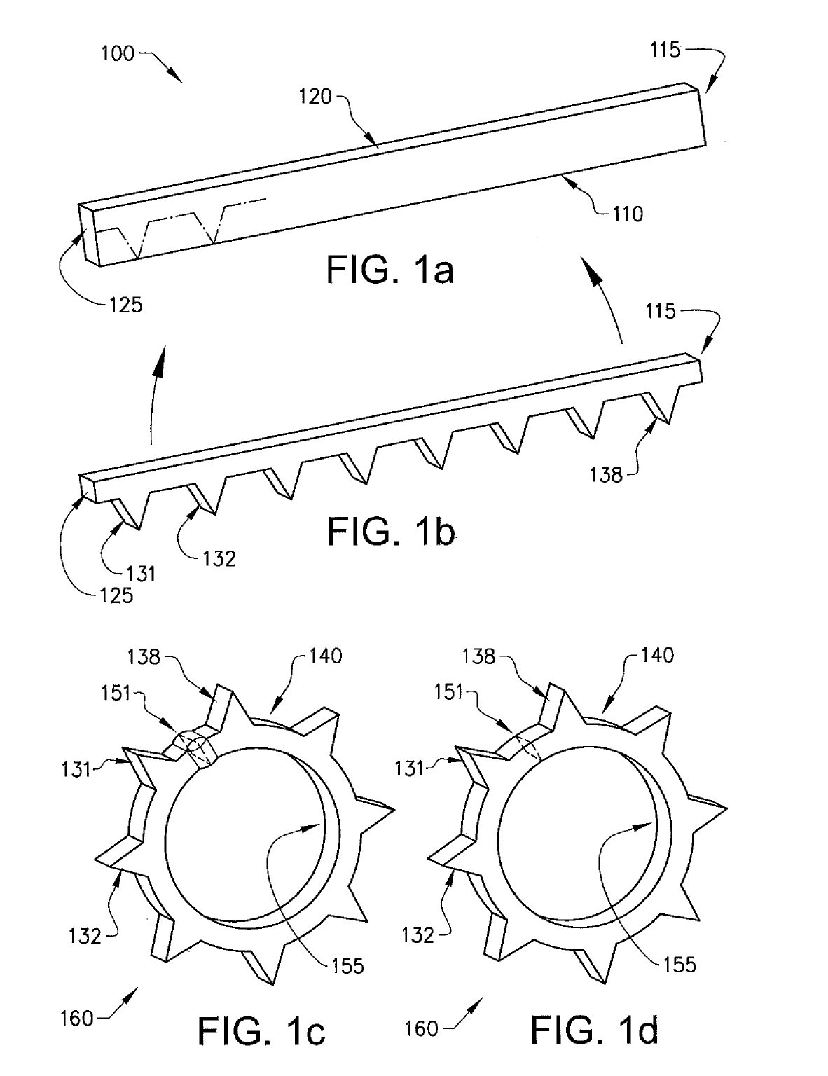

FIGS. 1a-1d show a method for obtaining a welded hollow gear ring of one embodiment of the invention. FIG. 1a shows an elongated steel bar 100 which exhibits a first 110 and a second 120 main surface which oppose each other, and which also exhibits two opposing distal ends 1 15, 125. Dashed lines in FIG. 1a outline a first gear structure which will be formed on the first main surface 110 of the steel bar 100.

In one embodiment, the first gear structure is formed on the first main surface 110 of the steel bar 100 by means of rolling.

In another embodiment, the first gear structure is formed on the first main surface 1 10 of the steel bar 100 by means of machining.

In another embodiment, the first gear structure is formed on the first main surface 1 10 of the steel bar 100 by a combination of rolling and machining.

These different ways of forming the gear structure offer different advantages: Using rolling to form the gear structure provides an exceptionally strong gear structure, due to the smooth and continuous material flow caused by rolling. Using machining to form the gear structure according to the invention is advantageous since the machining is performed on a steel bar, i.e. on a straight structure, as opposed to machining on the curved periphery of a ring, which makes the machining easier and thus less costly.

The gear structure which is formed by means of rolling can exhibit different forms and shapes, as will be elaborated upon later, but in the embodiment shown in FIGS. 1a-1c, the gear structure is formed to comprise cogs 131-138 shaped in the form of “teeth” i.e. protrusions with a pointed triangular structure, where the point faces away from the first main surface 110 of the steel bar on which the gear structure is formed. Suitably, the cogs are spaced evenly on the main surface of the steel bar, and are separated by intermediate spaces.

Yet another advantage given by the invention is that, as shown in FIGS. 1a and 1b, the gear structure is formed on a plane surface of a straight steel bar, which is easier than forming a gear structure on a ring shaped surface.

FIG. 1b shows the complete gear structure, i.e. the cogs 131-138 interleaved with spaces, formed on the first main surface 110 of the steel bar 100. As indicated by means of two arrows in FIG. 1b, the steel bear 110 will now be bent to form a ring, so that the two opposing distal ends 1 15, 125, of the steel bar 100 meet. The arrows of FIG. 1b indicate that the steel bar 1 10 is bent in a direction which will cause the gear structure to face outwards from an outer periphery of the ring which is formed. In another embodiment of the invention, the steel bar is bent in the other direction, so that the gear structure faces inwards from an inner periphery of the ring which is formed.

Once the steel bar has been bent to the ring-shape, the two opposing distal ends 115, 125, of the steel bar 100 are joined to each other by means of flash butt welding, so that a welding joint is formed in the ring. (For the sake of completeness, an example of how flash butt welding is performed will be given at the end of this text.) Suitably, in the case in which the gear structure comprises cogs, the welding joint is placed between two cogs, which is accomplished in the following manner: the gear structure is formed to comprise an entire cog 131 ,138, adjacent to each end 1 15, 125 of the steel bar or bars, thus enabling the flash butt welding to be performed between two cogs.

Naturally, the invention also comprises embodiments in which the flash butt welding is performed in a cog or a helical gear, in which case one part of a cog or a helical gear is formed on each of those bar ends which are then joined together by means of flash butt welding, so that a complete cog or helical gear is formed after the two ends have been joined to each other by the flash butt welding.

FIG. 1c shows a welded hollow gear ring 160 obtained by this embodiment of the invention. As can be seen from FIG. 1c, the welded hollow gear ring 160 exhibits an outer 140 and an inner 155 periphery, and also exhibits a gear structure on at least one of those peripheries, in the example shown in FIG. 1c the outer periphery 140. The gear structure in this example comprises the teeth shaped cogs 131-138, interleaved with spaces.

As can be seen in FIG. 1c, by means of the flash butt welding, a welding joint 151 is formed in the finished hollow gear ring 160, the welding joint 151 suitably being placed between two cogs 131 , 138.

FIG. 1d shows the welded hollow gear ring 160 of FIG. 1c, but here the flash butt welding joint has been smoothened, which for example can be done by means of machining.

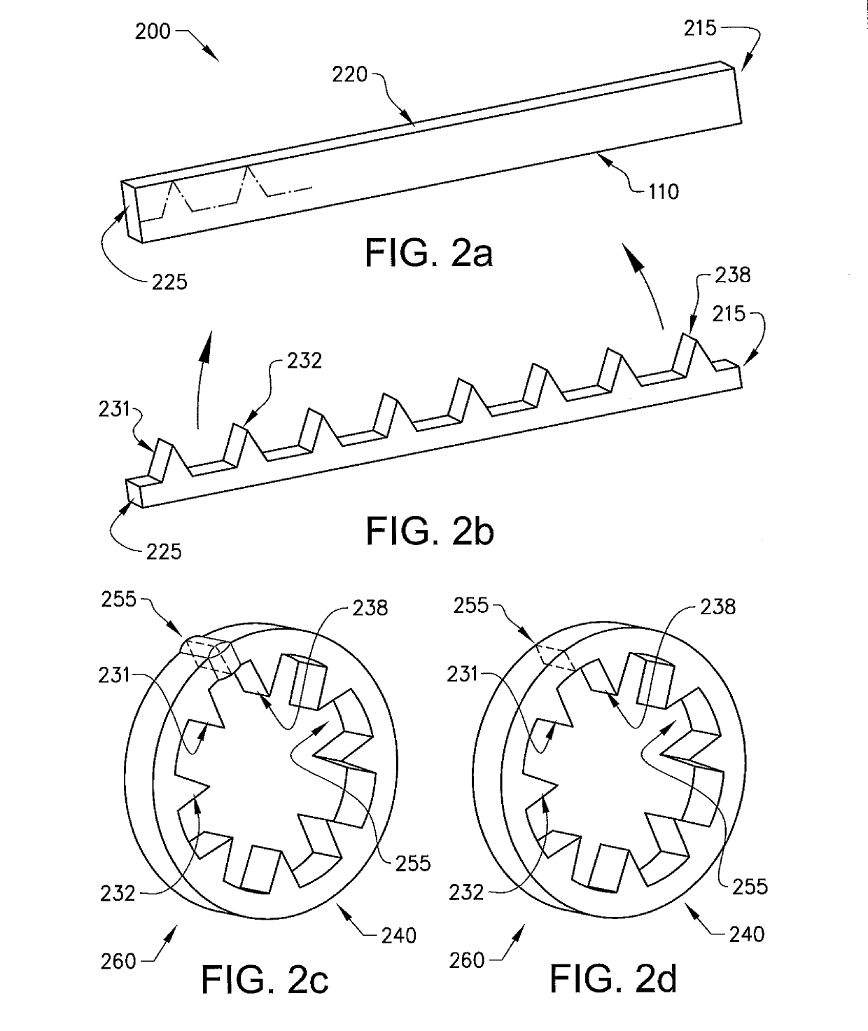

FIGS. 2a-2d show another embodiment both of the method of the invention and of a welded hollow gear ring (shown in FIG. 2c with the reference number 260) obtained by this embodiment: the method shown in FIGS. 2a and 2b, as well as the finished product 260 shown in FIG. 2c, will not be described in detail here due to the large similarity to that shown in FIGS. 1a-1c, but as can be seen, a gear structure (outlined by dashed lines in FIG. 2a) is formed, suitably by means of rolling, machining or a combination thereof, on a second main surface 220 of a steel bar 200, following which, FIG. 2b, the steel bar 200 is bent to a ring-shape, and two distal opposing ends 215, 225 of the steel bar 200 are joined to each other by means of flash butt welding, in the same manner as that described in connections with FIGS. 1a-1c. The hollow welded gear ring 260 which is obtained in this manner is thus similar to the one 160 of FIG. 1c, but with the difference that the gear structure faces inwards from the inner periphery 255 of the ring 260.

FIG. 2d shows the welded hollow gear ring 260 of FIG. 2c, but here the flash butt welding joint has been smoothened out, which for example can be done by means of machining.

Naturally, the embodiment 260 of FIGS. 2c and 2d can also be obtained by forming the gear structure on the first main surface 1 10 of the steel bar 100, as shown in FIG. 1a, and then bending the steel bar in a direction opposite to that shown by means of the arrows in FIG. 2b.

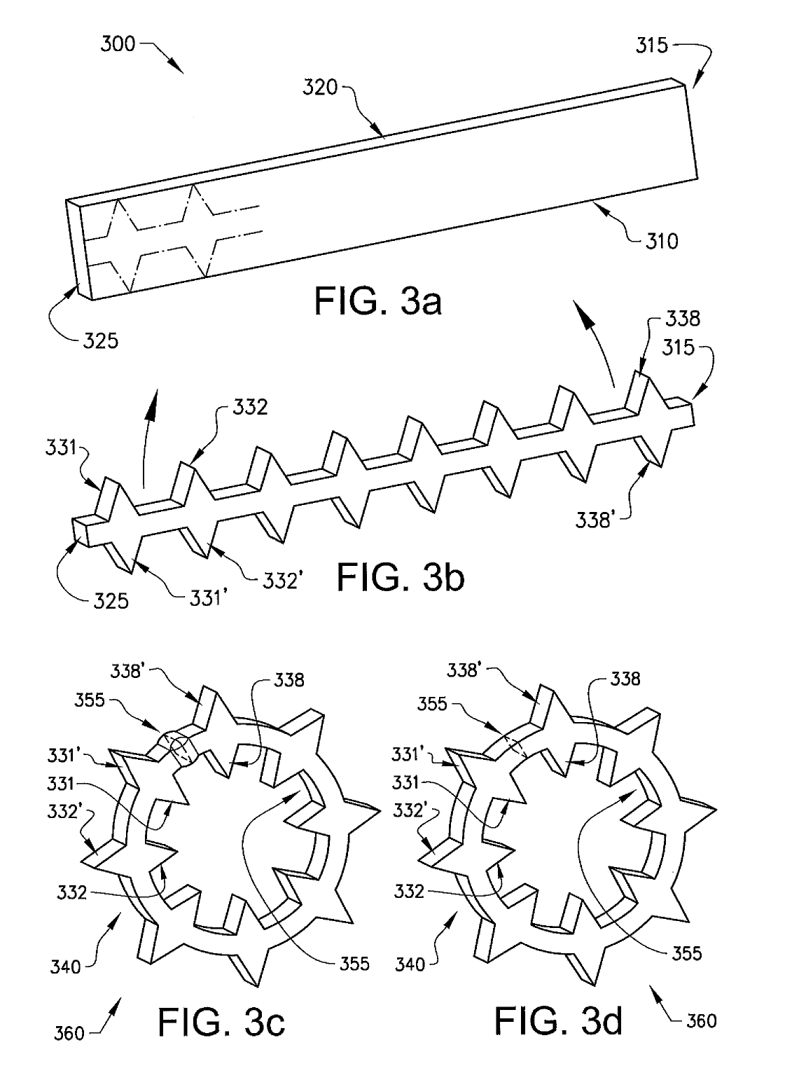

FIGS. 3a-3d show yet another embodiment of a method of the invention and how another embodiment of a hollow welded gear ring 360 is obtained: in this embodiment, as shown in FIGS. 3a and 3b, a first gear structure is formed, suitably by means of rolling, machining, or a combination thereof, on a first main surface 310 of a steel bar 300, in addition to which a second gear structure is formed by means of rolling on a second main surface 320 of the steel bar 300, where the first and second main surfaces 310, 320 are opposing main surfaces of the steel bar 300. Thus, both of the gear structures are formed by means of rolling. The first and the second gear structures are shown as comprising cogs in the shape of “teeth”, with the cogs of the first gear structure being shown as 331′-338′ and the cogs of the second gear structure being shown 331-338.

In this embodiment as well, the steel bar 300 is bent to form a ring-shape, and two opposing distal ends 315, 325, of the steel bar 300 are joined to each other by means of flash butt welding, in the same manner as that described in connections with FIGS. 1a-1c and 2a-2c. The hollow welded gear ring 360 which is obtained in this manner is thus similar to those shown in FIGS. 1c and 2c, but with the difference that it exhibits two gear structures, one which faces inwards from the inner periphery 355 of the ring 360, and one which faces outwards from the outer periphery 340 of the ring 360.

FIG. 3d shows the welded hollow gear ring 360 of FIG. 3c, but here the flash butt welding joint has been smoothened, which for example can be done by means of machining.

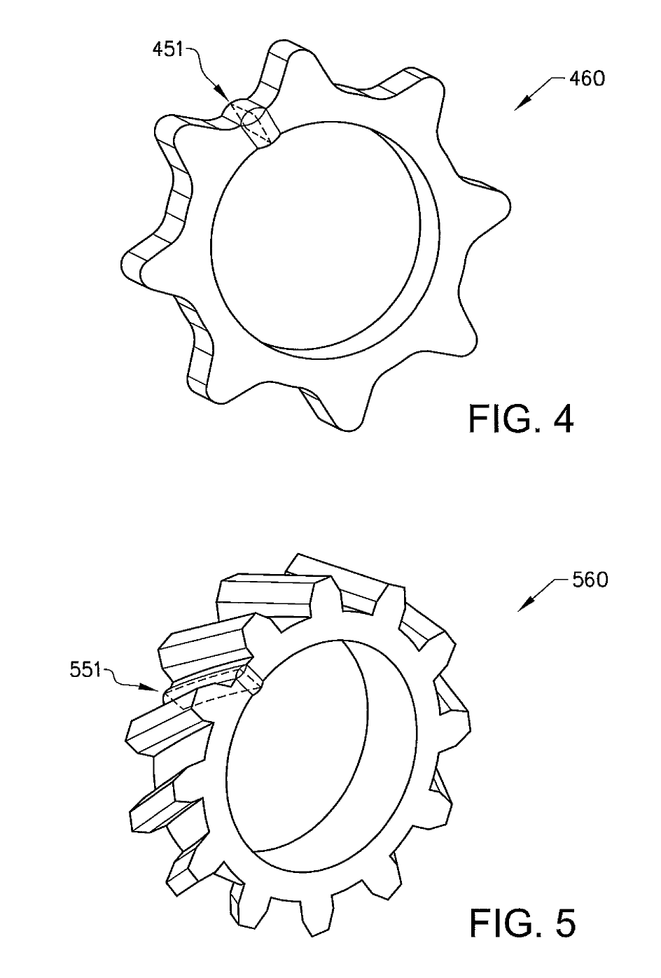

In the embodiments described so far, the gear structure has been described and shown as cogs in the form of “teeth” facing inwards and/or outwards. In another embodiment 460, shown in FIG. 4, the gear structure comprises cogs which exhibit a smooth structure with protrusions facing away from the periphery of the welded ring on which the gear structure is located. Naturally, such cogs can also be formed on either periphery of the hollow welded gear ring, or on both peripheries of the ring. The welding joint 451 caused by the flash butt welding is shown in FIG. 4.

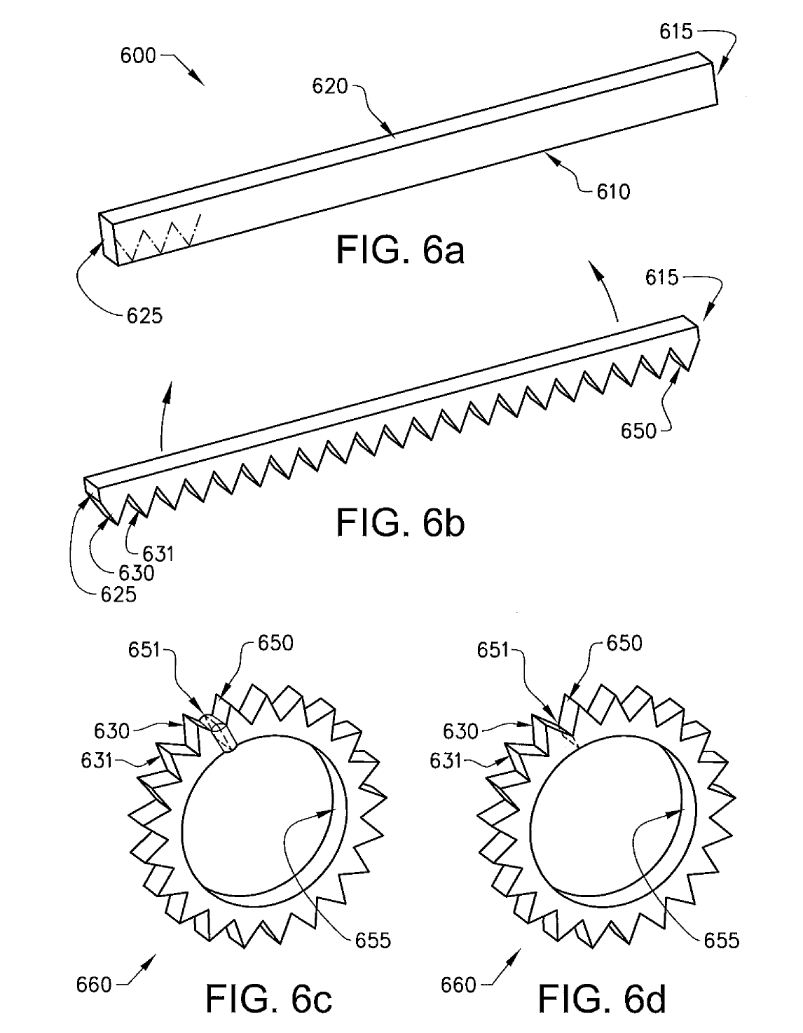

In yet another embodiment 560, shown in FIG. 5, the gear structure comprises helical gears. In such an embodiment, at least one welding joint is located between two helical gears, which is suitably done in the same manner as with the “cog embodiment”: the gear structure or structures is/are suitably formed to comprise an helical gear adjacent to each end of the steel bar or bars, thus enabling the flash butt welding to be performed between two helical gears. The same is the case for the “smooth cog embodiment” shown in FIG. 4, and for the “double cog embodiment” shown in FIGS. 3a-3d. The welding joint 551 caused by the flash butt welding is shown in FIG. 5.

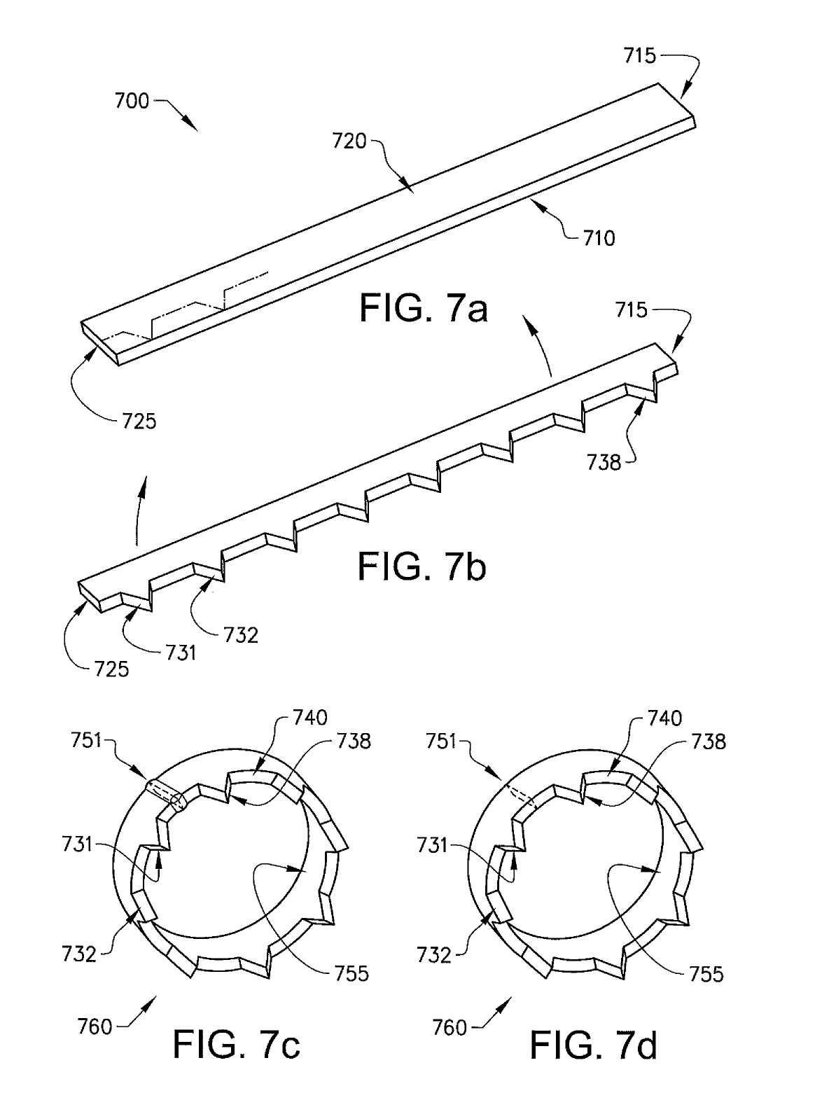

FIG. 6 shows a further embodiment 600 of a hollow gear ring of the invention, obtained in the same manner as the embodiments of FIGS. 1-5, but in this embodiment, the gear structure comprises cogs 630-650 placed immediately adjacent to each other. The welding joint 651 caused by the flash butt welding is shown in FIG. 6.

FIG. 7 shows yet a further embodiment 700 of a hollow gear ring of the invention, obtained in the same manner as the embodiments of FIGS. 1-6, but in this embodiment, the gear structure is formed so that the cogs 731-738 which are comprised in the gear structure point at a ninety degree angle from the outer periphery 140. Naturally, other angles can also be envisioned within the scope of the invention in this embodiment, as well as other shapes of the gear structure. The welding joint 751 caused by the flash butt welding is shown in FIG. 7.

FIGS. 1-3 show a method for obtaining a hollow gear ring by means of using one contiguous steel bar. However, the invention also discloses a method for obtaining a hollow gear ring by means of using two or more steel bars, as follows:

A first gear structure is formed on a first main surface of each of two or more elongated steel bars,

The two or more steel bars are bent so that they each form ring segments of a ring with a first radius,

Ends of the two or more steel bars are joined to each other by means of flash butt welding, in order to form a welded hollow gear ring with the first radius.

Thus, this embodiment of the invention comprises using at least two steel bars which are bent and then joined together to form the hollow gear ring, the joining being done by means of flash butt welding. The two (or more) steel bars which are used can be of equal lengths, which means that they will form equal parts of the hollow gear ring, or they can be of differing lengths, so long as they are bent to the same radius, so that the “circle segments” which they form fit together, although they are of different angular lengths.

Apart from the fact that multiple steel bars are used in this embodiment, so that more flash butt welding joints will be formed, the features mentioned above for the embodiment in which one steel bar is used to form the hollow gear ring can be applied to this embodiment as well, e.g. the form and shape of the gear structure as well as how the gear structure is formed and where it is placed on the hollow gear ring.

The use of one or more circle segments to form a hollow gear ring of the invention can also be expressed in the following manner:

a first gear structure is formed on a first main surface of at least one elongated steel bar,

the at least one steel bar is bent so that it forms a circle segment of a circle with a first radius,

ends of at least one steel bar are joined to each other by means of flash butt welding, in order to form a bearing ring with the first radius.

Thus, the circle segments mentioned here is either one circle segment of a complete (360 degree) circle, or portions of such a circle, which fit together to form a complete circle upon welding. Naturally, if more than one circle segment is used (i.e. each circle segment is less than 360 degrees), the surfaces on which the gear structures are formed face in the same direction.

Flash butt welding has been mentioned in the description above, and a short description of one version of flash butt welding will therefore be given in the following:

The ends of the steel bar, which have been brought to meet each other so that the steel bar is formed as a ring, are clamped between two dies, an upper and a lower die, where the upper die is in steel and the lower is in copper. The ends are brought together, and current is applied. An arc is thus created between the two mating surfaces, i.e. the surfaces of the two ends. At the beginning of the flash butt welding process, the arc gap is sufficiently large to even out and clean the two faces. Reducing and then closing and opening the gap creates heat in the two ends. When the temperature has reached the “forging” temperature, pressure is applied. A flash is created between the mating surfaces, which takes out potential impurities and defects from the welding area.

The invention is not limited to the examples of embodiments described above and shown in the drawings, but may be freely varied within the scope of the appended claims. For example, a welded hollow gear ring of the invention can have one kind of gear structure on one periphery and another kind on the other periphery, so that there for example is a gear structure with helical gears on the outer periphery and a gear structure with “teeth” on the inner periphery. In addition, it should be mentioned that certain kinds of gear structures which are formed by means of rolling can be enhanced, i.e. “finalized”, by means of machining. However, any such machining will be minor in its nature, and thus any disadvantages caused to the material by machining will be minor or negligible.

In addition, it should be made clear that although the invention has been described by means of a number of method embodiments, the invention also comprises the products, i.e. the welded hollow gear rings obtained by those methods, as outlined in the patent claims.

1. A welded hollow gear ring with an outer and an inner periphery,
the gear ring comprising a gear structure on at least one of said peripheries, and
at least one welding joint, the gear ring being characterized in that said at least one welding joint has been formed by flash butt welding.

2. The welded hollow gear ring of claim 1, in which said gear structure has been formed by rolling.

3. The welded hollow gear ring of claim 1, in which said gear structure has been formed by machining.

4. The welded hollow gear ring of claim 1, in which said gear structure has been formed by a combination of machining and rolling.

5. The welded hollow gear ring of claim 1, further comprising gear structure on both peripheries, wherein one gear structure is oriented facing outwards from said outer periphery and one gear structure is oriented facing inwards from said inner periphery of the ring.

6. The welded hollow gear ring of claim 1, in which said gear structure comprises cogs.

7. The welded hollow gear ring of claim 1, in which said gear structure comprises helical gears.

8. The welded hollow gear ring of claim 1, ins which said gear structures comprising at least one of a series of spatially arranged cogs and series of spatially arranged helical gears, and wherein said at least one welding joint is located between at least one of a pair of adjacently located cogs and a pair of adjacently located helical gears.

9. A method for manufacturing a welded hollow gear ring, the method being characterized in that it comprises the following:
forming a first gear structure on a first main surface of an elongated steel bar,
bending said steel bar to form a ring, so that two opposing distal ends of said steel bar meet one another,
joining said two opposing distal ends of said steel bar to each other by a process of flash butt welding.

10. A method for manufacturing a welded hollow gear ring, the method being characterized in that it comprises the following:
forming a first gear structure on a first main surface of at least two elongated steel bars,
bending said at least two steel bars so that each steel bar forms a ring segment of a ring with a first radius,
joining ends of said at least two steel bars to each other by a process of flash butt welding, in order to form a welded hollow gear ring with said first radius.

11. The method of claim 9, according to which said steel bar is bent so that said gear structure faces outwards from an outer periphery of said ring.

12. The method of claim 9, according to which said steel bar is bent so that said gear structure faces inwards from an inner periphery of said ring.

13. The method of claim 9, additionally comprising a step of forming a second gear structure on a second main surface of said steel bar, which second main surface is opposite to said first main surface of said steel bar, by means of which a welded hollow gear ring is obtained with one gear structure which faces inwards from an inner periphery of said ring and one gear structure which faces outwards from an outer periphery of said ring.

14. The method of claim 9, according to which said gear structure is formed by at least one of rolling and machining.

15. The method of claim 10, according to which said gear structures are formed by at least one of rolling and machining.

16. The method of claim 13 according to which said gear structures are formed by at least one of machining and rolling.

17. The method of claim 9, according to which said gear structure is formed to comprise at least one of a plurality of spatially arranged cogs and a plurality of spatially arranged helical gears.

18. The method of claim 10, comprising forming said gear structures to comprise at least one of a plurality of spatially arranged cogs and a plurality of spatially arranged helical gears.

19. The method of claim 17, according to which said gear structure is formed to comprise at least one of an entire cog and a helical gear adjacent to each end of said steel bar, thus enabling said flash butt welding to be performed between an adjacently located pair of said at least one of cogs and helical gears.

20. The method of claim 18, according to which said gear structures formed to comprise at least one of an entire cog and a helical gear adjacent to each end of said steel bars, thus enabling said flash butt welding to be performed between an adjacently located pair of said at least one of cogs and helical gears.
